(19) United States
(12) Patent Application Publication
(10) Pub. No.: US 2013/0064707 A1
(43) Pub. Date: Mar. 14, 2013

(54) MODELING APPARATUS, POWDER REMOVING APPARATUS, MODELING SYSTEM, AND METHOD OF MANUFACTURING A MODEL

(71) Applicants: Takeshi Matsui, Tokyo (JP); Hiroaki Morikawa, Kanagawa (JP); Kazuo Niizaka, Tokyo (JP); Junichi Kuzusako, Saitama (JP); Nobuhiro Kihara, Kanagawa (JP)

(72) Inventors: Takeshi Matsui, Tokyo (JP); Hiroaki Morikawa, Kanagawa (JP); Kazuo Niizaka, Tokyo (JP); Junichi Kuzusako, Saitama (JP); Nobuhiro Kihara, Kanagawa (JP)

(73) Assignee: SONY CORPORATION, Tokyo (JP)

(21) Appl. No.: 13/604,161

(22) Filed: Sep. 5, 2012

(30) Foreign Application Priority Data
Sep. 8, 2011 (JP) 2011-195882

(51) Int. Cl. B29C 67/24; B22F 5/00

(52) U.S. Cl. 419/61; 425/78; 425/438; 264/109

(57) ABSTRACT

A modeling apparatus includes a box holding mechanism, a box, a supply mechanism, and an elevation mechanism. The box includes a main body and a stage movably provided to the main body. The box is capable of accommodating powder and detachably provided to the box holding mechanism. The supply mechanism is configured to selectively supply liquid that bonds the powder together to a modeling enabled area inside the box. The elevation mechanism is configured to cause the stage to ascend and descend in the main body relative to the main body.

### CROSS REFERENCES TO RELATED APPLICATIONS

The present application claims priority to Japanese Priority Patent Application JP 2011-195882 filed in the Japan Patent Office on Sep. 8, 2011, the entire content of which is hereby incorporated by reference.

### BACKGROUND

The present disclosure relates to a modeling apparatus that forms a model from a powdered material on a basis of a technology of rapid prototyping, a powder removing apparatus that removes powder around the model, a modeling system that includes such apparatuses, and a method of manufacturing a model.

A modeling apparatus disclosed in Japanese Patent Application Laid-open No. 2002-248691 is provided with, for example, an additive manufacturing unit 20 and a powder removing unit 30. In this additive manufacturing unit 20, an additive manufacturing process to produce a model 91 is performed on a stage 9. This stage 9 is configured to descend by means of a stage transporting section 50. When the model 91 is produced in the additive manufacturing unit 20, the stage 9 descends and the powder removing unit 30 starts a powder removing process (see, for example, paragraphs [0060] and [0070] and FIGS. 1, 4, and 7 of Japanese Unexamined Patent Application Publication No. 2002-248691).

In such a modeling apparatus, operation from a modeling process through a powder removing process is conducted automatically.

### SUMMARY

In an ordinary modeling apparatus, in which operation from a modeling process through a powder removing process cannot be performed automatically, when a model is formed in the modeling apparatus, a worker has to take the model out from a modeling unit installed in the apparatus. This reduces modeling efficiency.

In view of the circumstances as described above, there is a need for a modeling apparatus that can enhance modeling efficiency, a powder removing apparatus (a de-powdering device) used thereto, a modeling system, and a method of producing a model.

According to an embodiment of the present disclosure, there is provided a modeling apparatus including a box holding mechanism, a box, a supply mechanism, and an elevation mechanism.

The box includes a main body and a stage movably provided to the main body. The box is capable of accommodating powder and is detachably provided to the box holding mechanism.

The supply mechanism is configured to selectively supply liquid that is used to bond the powder together to a modeling enabled area inside the box.

The elevation mechanism is configured to cause the stage to ascend and descend in the main body relative to the main body.

With the box being held detachably by the box holding mechanism, a worker or a robot is able to detach the box from the box holding mechanism. The worker or the robot is able to take a model out of this detached box or able to set the box accommodating the model to a powder removing apparatus. This configuration enhances operation efficiency.

The elevation mechanism may include an elevating member that is driven to ascend and descend and a clamping mechanism by which the elevating member clamps the stage.

For example, the clamping mechanism may perform clamping by the use of an electromagnet. With the box being held detachably by the box holding mechanism or the stage being provided movably relative to the main body of the box, a problem of misalignment resulting from manufacturing error (for example, a difference in size) may arise between the box and the stage. However, the clamping mechanism according to an embodiment of the present disclosure absorbs the misalignment resulting from manufacturing error, whereby the clamping is accomplished.

The box may include a supported member provided on a side surface of the main body. In this case, the box holding mechanism includes a supporting member provided to be able to ascend and descend and to support this supported member from below. With this configuration, the box holding mechanism is able to raise the box easily as the supported member is pushed upward when the supporting member ascends.

The box holding mechanism may include a stopper on which the supported member supported by the supporting member abuts. This stopper may be used as a part or the whole of a box positioning mechanism, whereby positioning of the pox is enabled with a simple mechanism.

The box may include a seal member attached around the stage. This prevents powder from leaking and dropping from inside the box.

According to an embodiment of the present disclosure, there is provided a powder removing apparatus including a box holding mechanism, a box, a stage moving mechanism, and a powder removing mechanism.

The box includes a main body having an opening and a stage movably provided to the main body. This box is detachably provided to the box holding mechanism and to be capable of accommodating a model and unbonded powder with this model formed of powder by rapid prototyping technology being disposed, together with the unbonded powder, on the stage.

The stage moving mechanism is capable of causing the stage to ascend in the main body relative to the main body.

The powder removing mechanism removes unbonded powder around the model, which is pushed out of the box through the opening by driving of the stage moving mechanism.

According to an embodiment of the present disclosure, there is provided a modeling system including the modeling apparatus, the powder removing apparatus, and a transportation apparatus transporting the box between the modeling apparatus and the powder removing apparatus.

According to an embodiment of the present disclosure, there is provided a method of manufacturing a model including accommodating powder in a box having a main body and a stage movably provided to the main body.

In the box, a model is formed of the powder by rapid prototyping technology in a modeling apparatus.

The box is detached from the modeling apparatus.

The detached box is set to a powder removing apparatus.

Unbonded powder around the model is removed by the powder removing apparatus.

According to the embodiments of the present disclosure explained above, efficiency of modeling operation can be enhanced.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 shows a view of a modeling apparatus according to an embodiment of the present disclosure;

FIG. 2 shows a side view of the modeling apparatus in FIG. 1;

FIG. 3 shows a plan view of the modeling apparatus in FIG. 1;

FIGS. 4A and 4B show a perspective view of a box provided in a modeling section and a cross sectional view of this box, respectively;

FIG. 5 shows a view of main parts of a supply section and a modeling section, viewed from diagonally lower parts of these sections;

FIG. 6 shows a side view of the supply section and the modeling section, viewed from a side of the supply section;

FIG. 7 shows a flowchart describing operation performed mainly when the box is set to the modeling apparatus;

FIG. 8 shows a view of the box being held by a cart;

FIG. 9 shows a perspective view of the cart and the modeling apparatus before a worker inserts the forks of the cart into the modeling apparatus;

FIG. 10 shows a perspective view of the cart and the modeling apparatus in a state where the forks of the cart has been inserted into the modeling apparatus by the worker;

FIGS. 11A to 11E show views explaining operation of a box holding mechanism in the above-mentioned state;

FIGS. 12A to 12D show schematic side views, illustrating modeling processing performed by the modeling apparatus, sequentially;

FIG. 13 shows a flowchart describing mainly operation implemented when the box is detached from the modeling apparatus after the modeling processing by the modeling apparatus;

FIG. 14 shows a perspective view of an external appearance of a powder removing apparatus according to the embodiment of the present disclosure;

FIG. 15 shows a schematic cross sectional view of the powder removing apparatus in FIG. 14;

FIG. 16 shows a view explaining operation by this powder removing apparatus; and

FIG. 17 shows a view illustrating how the model is removed from this powder removing apparatus.

### DETAILED DESCRIPTION

Hereinafter, embodiments of the present disclosure will be described with reference to the drawings.

[Modeling Apparatus]

(Constitution of Modeling Apparatus)

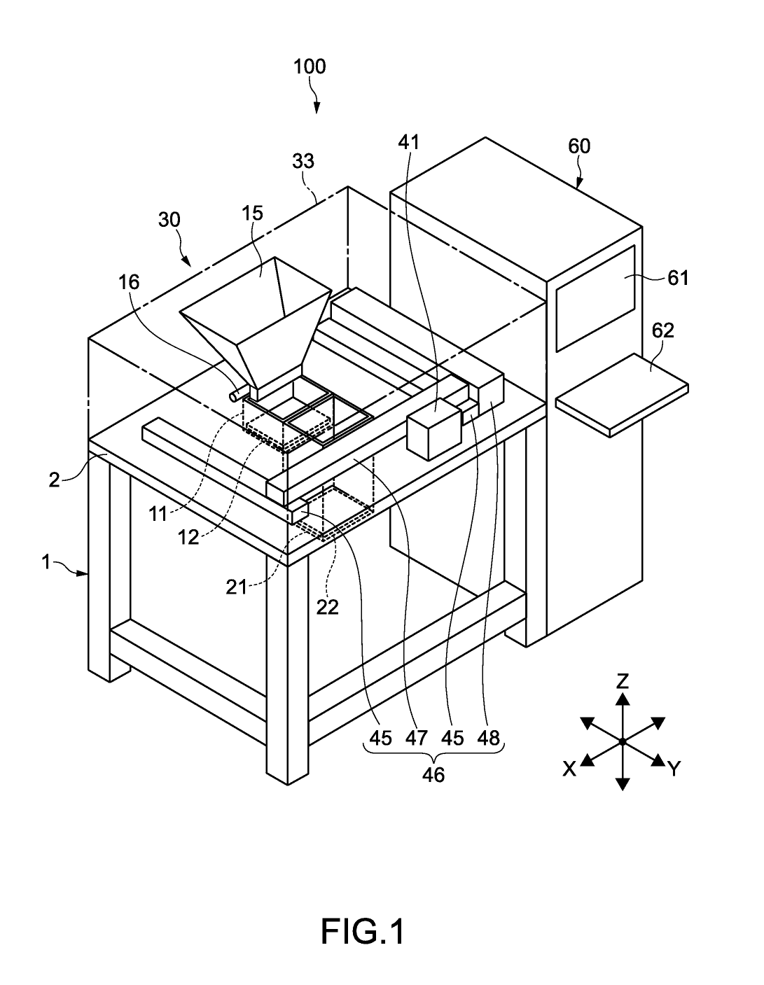

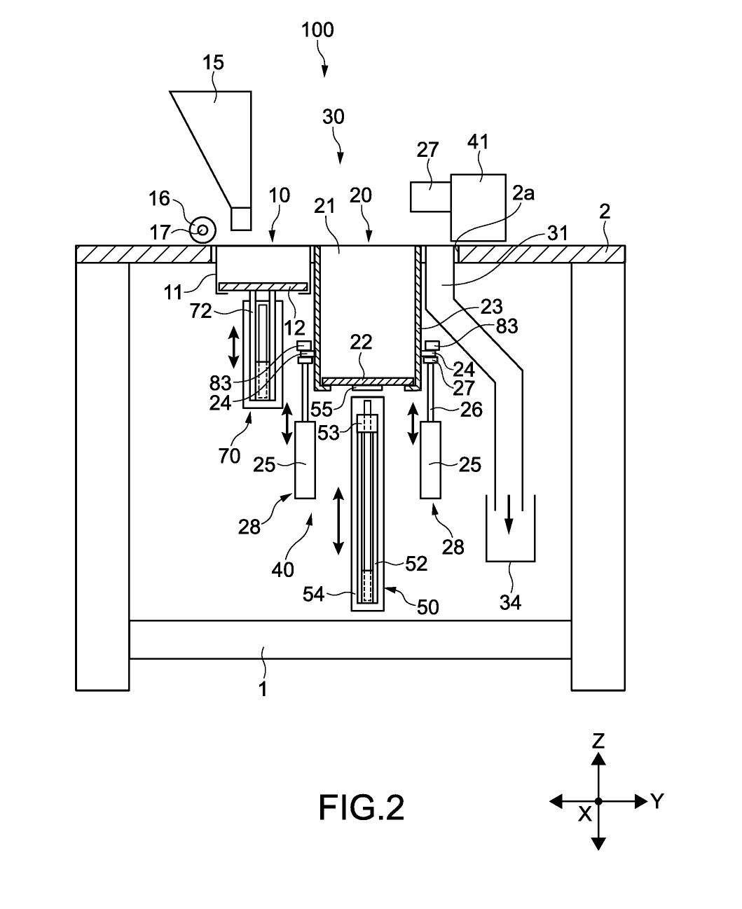

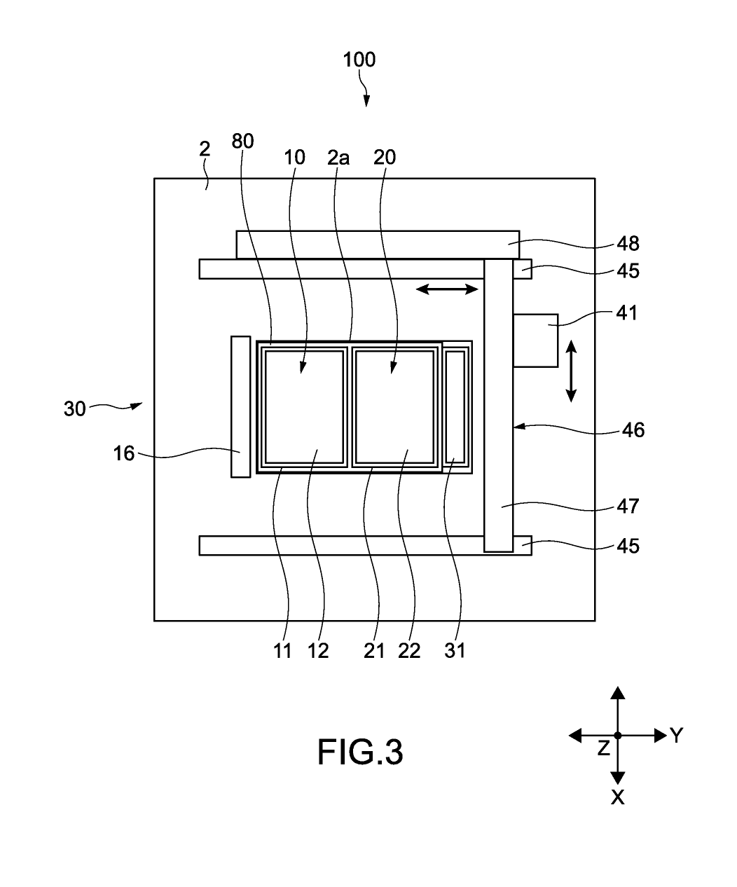

FIG. 1 shows a view of a modeling apparatus according to an embodiment of the present disclosure. FIG. 2 shows a side view of the modeling apparatus in FIG. 1, and FIG. 3 shows a plan view of the modeling apparatus.

The modeling apparatus according to the embodiment of the present disclosure is represented by a modeling apparatus 100 that forms a model from a powdered material by the use of rapid prototyping technology.

The modeling apparatus 100 is constituted by a modeling unit 30 and a control unit 60 arranged adjacent thereto. The modeling unit 30 has a frame 1 and a plate 2 fixed to the upper part of the frame 1. At substantially the center of the plate 2, an opening 2a for supplying powder during modeling operation is formed along the Y-direction, which is the longitudinal direction of the plate 2. Below the opening 2a, a supply section 10 that supplies powder, a modeling section 20 that forms a model from powder, and a discharge passage member 31 that discharges powder (omitted in FIG. 1) are arranged. As shown in FIG. 2 and FIG. 3, the supply section 10, the modeling section 20, and the discharge passage member 31 are arranged in order along the Y-direction from the left side of the figures.

Another frame (not shown in figures) is provided over the plate 2 and a cover 33 is mounted over the frame, as shown in FIG. 1. The cover 33 is made of, for example, acryl so that a user of the apparatus can look inside the modeling unit 30 through the cover 33. Moreover, antistatic treatment is applied to this cover 33 to prevent electrostatically charged powder from being attached thereto, whereby the visibility of the inside is ensured for the user.

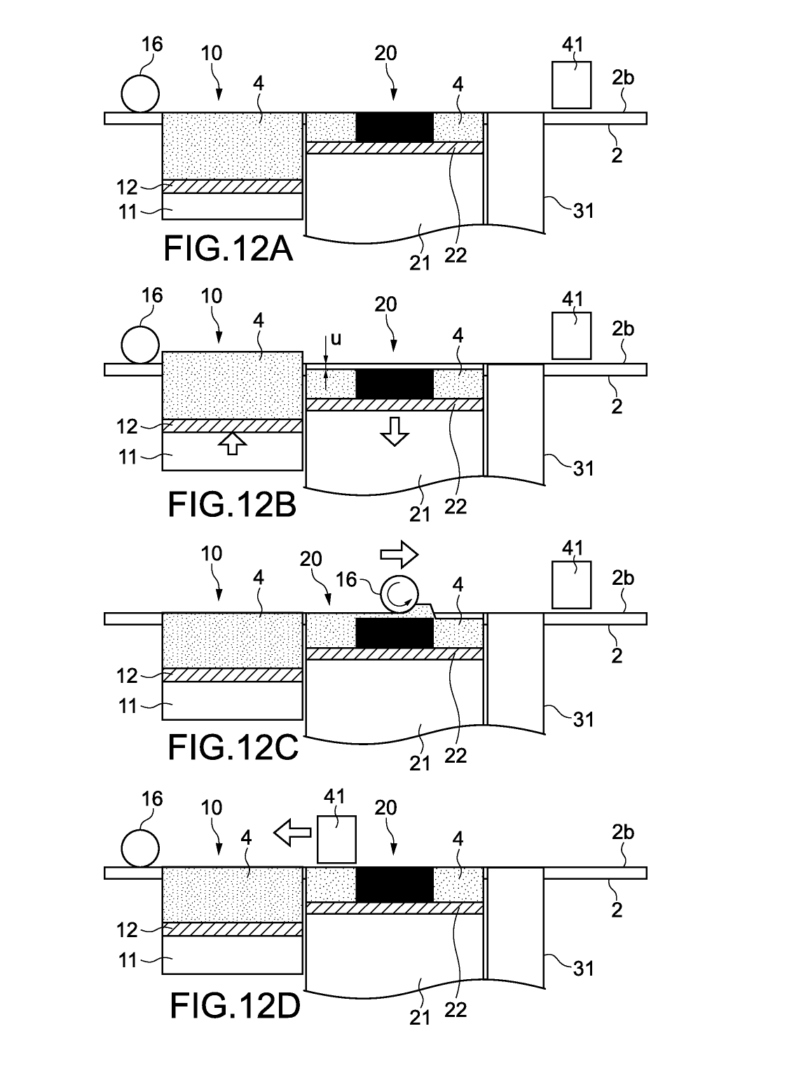

The supply section 10 has a supply box 11 that can store powder 4 (see FIG. 12) and that includes a supply stage 12, and an elevation mechanism 70 in which the supply stage 12 ascends and descends inside the supply box 11. The supply stage 12 pushes up the powder 4 stored in the supply box 11 by driving of the elevation mechanism 70, whereby the powder 4 is supplied onto the plate 2 through the opening 2a. For example, either a ball screw mechanism or a rack-and-pinion mechanism may be utilized as the elevation mechanism 70.

As shown in FIG. 1 and FIG. 2, a tank chute 15, which is fed with powder due to operation of a worker or a robot and which stores the same temporarily, is provided above the supply section 10. The bottom of this tank chute 15 is provided with a cover (not shown in figures) that opens and closes by, for example, electric control. When this cover opens, the powder stored in the tank chute 15 drops under its own weight and is supplied to the supply section 10.

The powder 4 may be formed of a water-soluble material, for example, inorganic substances as represented by salt, magnesium sulfate, magnesium chloride, potassium chloride, and sodium chloride. A substance mixed with sodium chloride and bittern components (e.g., magnesium sulfate, magnesium chloride, and potassium chloride) may also be used. These are, in other words, components containing sodium chloride as a primary component. Alternatively, an organic substance such as polyvinyl-pyrrolidone, polyvinyl alcohol, carboxymethyl cellulose, ammonium polyacrylate, sodium polyacrylate, ammonium methacrylate, and sodium methacrylate, or copolymer thereof may be used.

Typically, the average particle diameter of the powder 4 is not less than 10 μm but not greater than 100 μm. With salt being utilized, more energy may be saved when, for example, extracting or processing a powdered material, as compared with a case where, for example, a metal or plastic powdered material is utilized. This contributes to environmental protection.

The modeling section 20 arranged adjacent to the supply section 10 has a box 21, which is capable of accommodating the powder 4, and an elevation mechanism 50, in which a stage 22 inside this box 21 is driven to ascend and descend. The box 21 is provided detachably in a box holding mechanism 40. The box holding mechanism 40 and the elevation mechanism 50 will be explained in detail later.

With regard to the size of the box 21 shown, for example, in FIG. 3, this box may have a length of 20 cm to 50 cm in the X-direction and 10 cm to 30 cm in the Y-direction. However, the lengths in these directions are not limited to the above ranges. An area where the powder accommodated in (a main body 23 of) the box 21 is arranged is a modeling enabled area.

Openings are formed respectively in upper ends of the boxes 11 and 21 and the discharge passage member 31. Each of the opening surfaces of these openings is arranged so as to face the opening 2a of the plate 2 (see FIG. 3).

On the plate 2, near an end portion of the opening 2a on a side of the supply section 10, a roller 16 that transports the powder 4 supplied from the supply section 10 to the modeling section 20 is provided. The roller 16 has a rotating shaft 17 (see FIG. 2) along a direction—the X-direction—orthogonal to a direction of arrangement of the boxes 11 and 21 and the discharge passage member 31 on a horizontal plane. A motor (not shown in figures) is also provided in order to turn the rotating shaft 17. There is also provided on the plate 2 a mechanism (not shown in figures) that moves the roller 16 in the Y-direction.

The discharge passage member 31 is bent to obtain a sufficient space for arranging the box holding mechanism 40 as shown in FIG. 2. A collection box 34 is arranged under the discharge passage member 31. An excess of the powder that drops under its own weight through the discharge passage member 31 is collected in this collection box 34.

On the plate 2, a print head 41 and a print head moving mechanism 46 that moves this print head 41 in the X-Y direction are provided. The print head 41 is capable of ejecting ink onto the powder 4 disposed on the stage 22 in the modeling section 20. The print head 41 and the print head moving mechanism 46 function as a supply mechanism that supplies liquid.

The print head moving mechanism 46 has a pair of guiderails 45 extending along the Y-direction on both sides of the opening 2a in the X-direction, a Y-axis driving mechanism 48 that is provided at the end of one of the guide rails 45, and an X-axis driving mechanism 47 that is disposed linking the pair of guiderails 45. The print head 41 is coupled to the X-axis driving mechanism 47 to be able to move in the X-direction. By means of a Y-axis driving mechanism 48, the X-axis driving mechanism 47 is capable of moving in the Y-direction along the pair of guiderails 45. The X-axis driving mechanism 47 and Y-axis driving mechanism 48 are constituted in the form of, for example, a ball screw mechanism, a belt mechanism or a rack-and-pinion mechanism.

The print head 41 may be a device that has a structure of an inkjet print head in related arts. For example, a plurality of ink tanks (not shown in figures) may be provided in the print head 41. Each of these tanks may store cyan, magenta, and yellow ink (hereinafter referred to as “CMY”).

Although not shown in figures, for example, a tank that stores transparent ink may be provided in the print head 41. This transparent ink may contain a binder component that induces powder to be bonded together and cured. When the powder contains such a binder component, the ink may not have to include the same.

As the ink, water based ink (e.g., ink for inkjet printers available commercially) may be used. Moreover, depending on the material of the powder 4, solvent ink may be used.

As the system of the print head 41, a system different from the inkjet system may be employed.

The control unit 60 has functions of a computer provided with a central processing unit (CPU), random access memory (RAM), and read-only memory (ROM). Moreover, the control unit 60 includes a display section 61 provided at the upper part on the front face of this unit and an input operation device 62 provided at the lower part thereof Typically, the input operation device 62 may be provided in the form of a keyboard while the display section 61 may include an input device in the form of a touch screen.

To this control unit 60, computed tomography (CT) data serving as three dimensional data are input. On the basis of the input CT data, the control unit 60 controls operation and operation timing of each section of the modeling unit 30 to form a model.

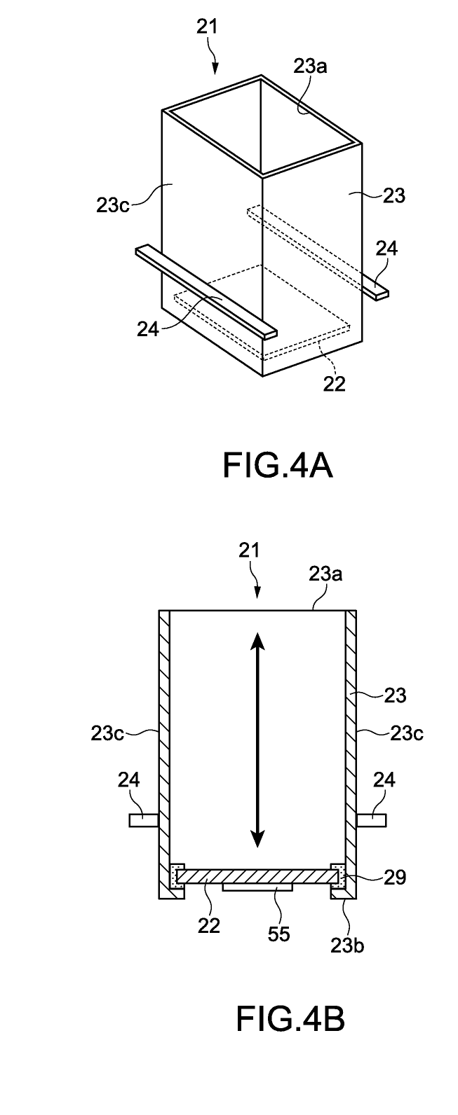

FIGS. 4A and 4B show a perspective view of the box 21 provided in the modeling unit 20 and a cross sectional view of this box, respectively.

As thus explained, the box 21 has the main body 23 having the opening 23a formed at the upper end thereof and the stage 22 that is provided to be able to move in the main body 23 and that constitutes the bottom of the main body 23. The main body 23 has a rectangular tubular shape. The stage 22 is a rectangular plate that is shaped to correspond to the internal shape of the main body 23. As shown in FIG. 4B, the main body 23 has at its lower end a flange 23b. The main body 23 is formed to have the largest capacity in a state where the peripheral edge of the stage 22 is placed on the flange 23b.

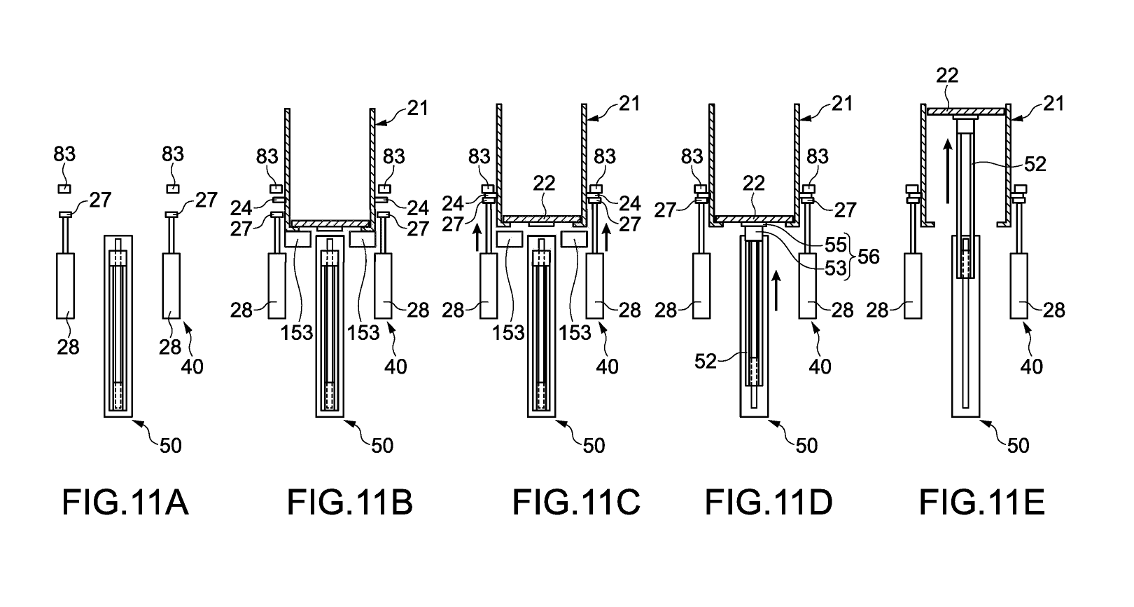

A seal member 29 is attached to the peripheral edge of the stage 22 to seal a gap between the main body 23 and the stage 22. This seal member 29 is made of a sponge material, for example, urethane. A steel plate 55, which is made of, for example, a ferromagnetic material, is attached, as a member constituting part of a clamping mechanism 56 (which will be explained later), to the rear surface of the stage 22. In FIG. 2 and FIGS. 11A to 11E and the like, the seal member 29 is omitted.

On side surfaces (23c) of the main body 23 of the box 21, supported members 24 to be supported by supporting members 27 (which will be described later) of the box holding mechanism 40 are provided. The supported members 24 may be formed to have, for example, a plate-like shape, but their shapes are not limited to a plate-like shape. The supported members 24 may be provided continuously or intermittently at least at a part of the periphery of the main body 23 so that the supporting members 27 of the box supporting mechanism 40 can support the box 21. In the present embodiment, the supported members 24 are provided respectively at the side surfaces 23c that face each other.

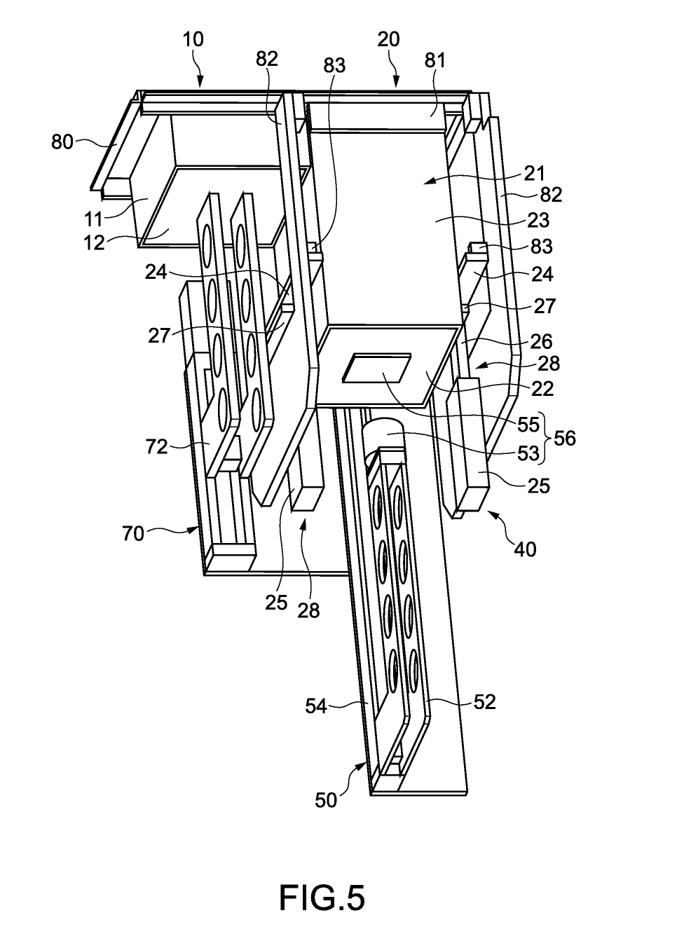

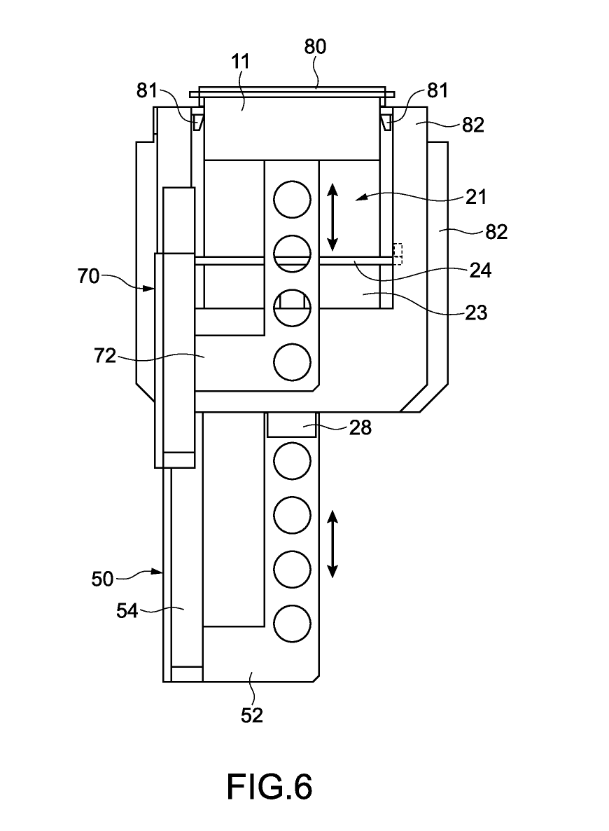

FIG. 5 shows a view of main parts of the supply section 10 and the modeling section 20, viewed from diagonally lower parts of these sections. FIG. 6 shows a side view of the supply section 10 and the modeling section 20, viewed from the side of the supply section 10. The following explanation of the supply section 10 and the modeling section 20 is understood more easily when FIG. 2 is referenced in addition to FIGS. 5 and 6.

The supply section 10 and the modeling section 20 have an attachment frame 80 that is attached to the opening 2a of the plate 2. The supply box 11 is fixed to a predetermined position of this attachment frame 80.

To the attachment frame 80, a guide frame 81 is attached at a position adjacent to the position where the supply box 11 is fixed. The guide frame 81 may be, for example, a rectangular frame whose shape is in alignment with the contour of the main body 23. The guide frame 81 has a function of positioning the main body 23 by guiding the upper part of the main body 23 of the box 21 when the box 21 is set to the box holding mechanism 40.

As shown in FIG. 6, the inner side of the guide frame 81 has a tapered shape. More specifically, the inner side of the guide frame 81 is formed such that a width of the inner side of this frame (a width of the space within the periphery of the guide frame 81) gradually decreases from the lower part to the upper part thereof By this configuration, the upper part of the box 21, which is caused to ascend as described later, can be more easily guided. In other words, the upper part of the box 21 can be caused to fit in the guide frame 81 more easily, whereby positioning of the box 21 can be implemented with ease.

The elevation mechanism 50 of the modeling section 20 includes a driving section 54, an elevating arm (an elevating member) 52 that ascends and descends by actuation of the driving section 54, and the clamping mechanism 56 (see FIG. 5), by which the elevating arm 52 clamps the stage 22. The elevating arm 52 may be L-shaped.

The clamping mechanism 56 may have, for example, a magnetic field generating device 53 attached to the upper part of the elevating arm 52, and the steel plate 55 provided on the rear surface of the stage 22, as described above. The magnetic field generating device 53 generates magnetic force by energizing a coil (not shown in figures) and this magnetic force reacts with the steel plate 55. This results in coupling between the magnetic field generating device 53 and the steel plate 55, whereby the stage 22 is clamped.

The elevation mechanism 70 of the supply section 10 has a structure that is basically identical to that of the elevation mechanism 50, although the former differs from the latter in that the supply stage 12 is directly attached to one end of the L-shaped elevating arm 72 in the elevation mechanism 70.

The box holding mechanism 40 provided in the modeling section 20 has a pair of elevating cylinders 28. Each of the elevating cylinders 28 has a drive section 25 and a rod 26 that is driven to ascend and descend by the drive section 25. Each of the supporting members 27 is attached to the end of the rod 26. This is to cause the supporting members 27 to support the supported members 24, which are provided to the box 21, from below. The elevating cylinders 28 may be fluid pressure cylinders (typically air cylinders).

The elevating cylinders 28 are fixed respectively to a pair of perpendicular frames 82, which are connected to the attachment frame 80, at a position sandwiching the box 21 and the elevating arm 52. A controller (not shown in figures) of the modeling unit 30 or the control unit 60 controls the pair of elevating cylinders 28 so that these cylinders are driven in synchronization.

A pair of stoppers 83 that function as part of the box holding mechanism 40 is provided to the pair of perpendicular frames 82. The stoppers 83 have a function of regulating the elevation of the supporting members 27 when the elevating cylinders 28 elevate the supporting members 27. As explained later, at a point in time when the supported members 24 come into contact with the stoppers 83, positioning of the box 21 is completed by means of the guide frame 81. The guide frame 81 may function as part of the box holding mechanism 40.

In this way, with the guide frame 81 and the stoppers 83 being provided, positioning of the box 21 in the modeling section 20 can be realized in a simple configuration.

(Operation Prior to Modeling Processing in Modeling Apparatus)

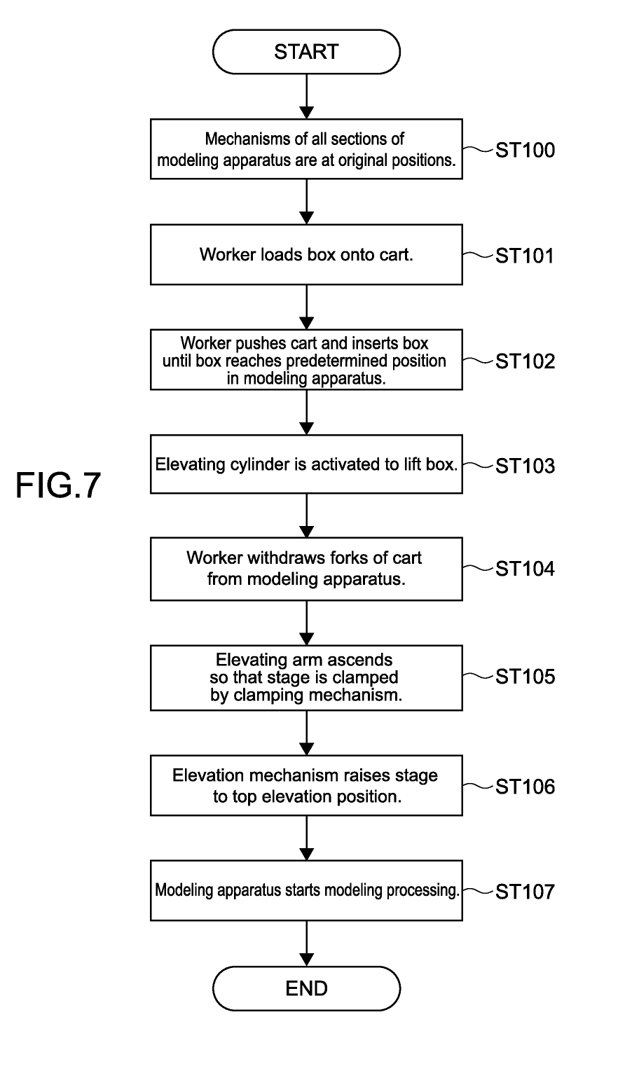

Next, operation of setting the box 21 to the modeling apparatus 100 is explained mainly. FIG. 7 shows a flowchart that describes this operation. FIGS. 11A to 11E show views explaining the operation of the box holding mechanism.

Before operation, mechanisms of all sections of the modeling apparatus 100 are at original positions (initial positions) (Step 100). The original position of the box holding position 40 is shown in FIG. 11A. More specifically, at this original position, the supporting members 27 of the elevating cylinders 28 are at positions lower than their positions shown in FIG. 2.

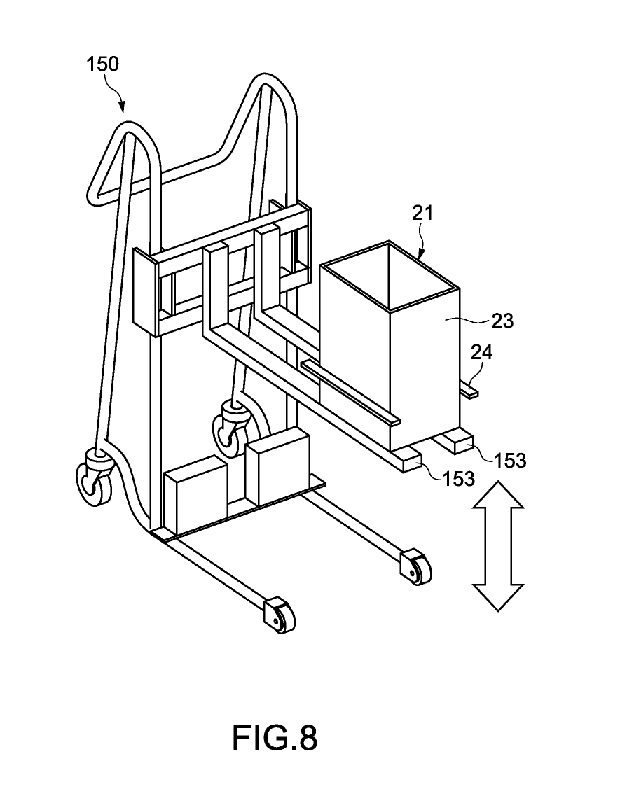

As shown in FIG. 8, a worker loads the box 21 onto a cart 150 (Step 101). The cart 150 has a pair of forks 153 that hold the box 21 to be carried thereon. The forks 153 are configured to move vertically by manual or electric operation. The forks 153 hold the box 21 thereon by supporting the box 21 from below, as shown in FIG. 8. The position of the forks 153 are adjusted to be at a predetermined height so that the box 21 will be arranged on the pair of elevating cylinders 28 of the modeling apparatus 100 when the worker inserts the forks 153 of the cart 150 into the modeling apparatus 100, as will be described later.

The upper surface of each of the forks 153 may be provided with a protrusion or a recess (not shown in figures) to be mutually engaged with a recess or a protrusion provided on the rear surface of the box 21. In place of the forks 153, the cart 150 may have a holding mechanism that holds the box 21 by holding the main body 23 of the box 21 from opposite sides thereof.

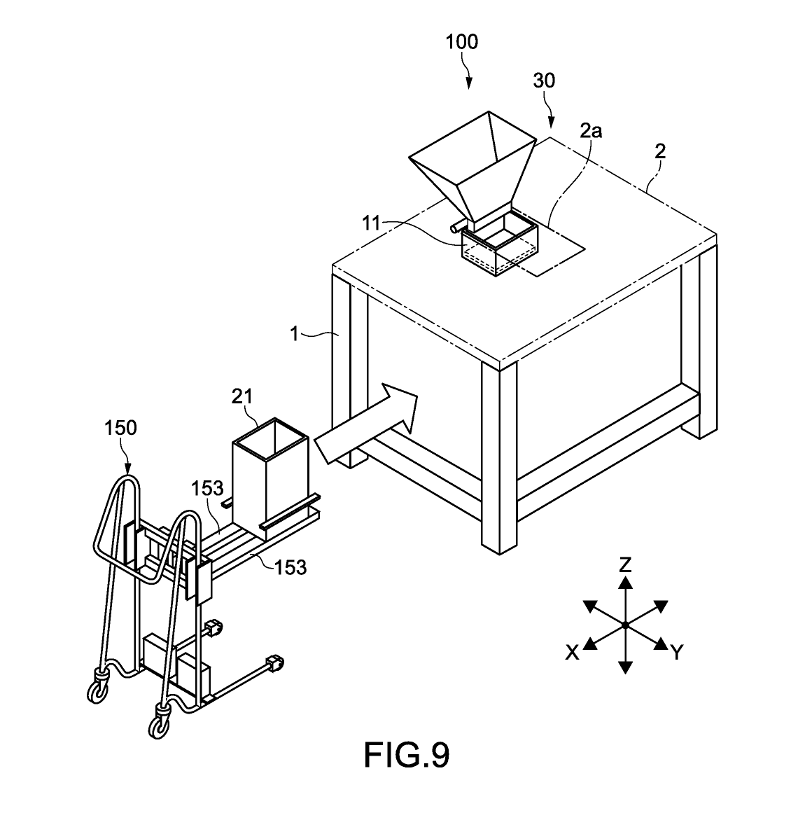

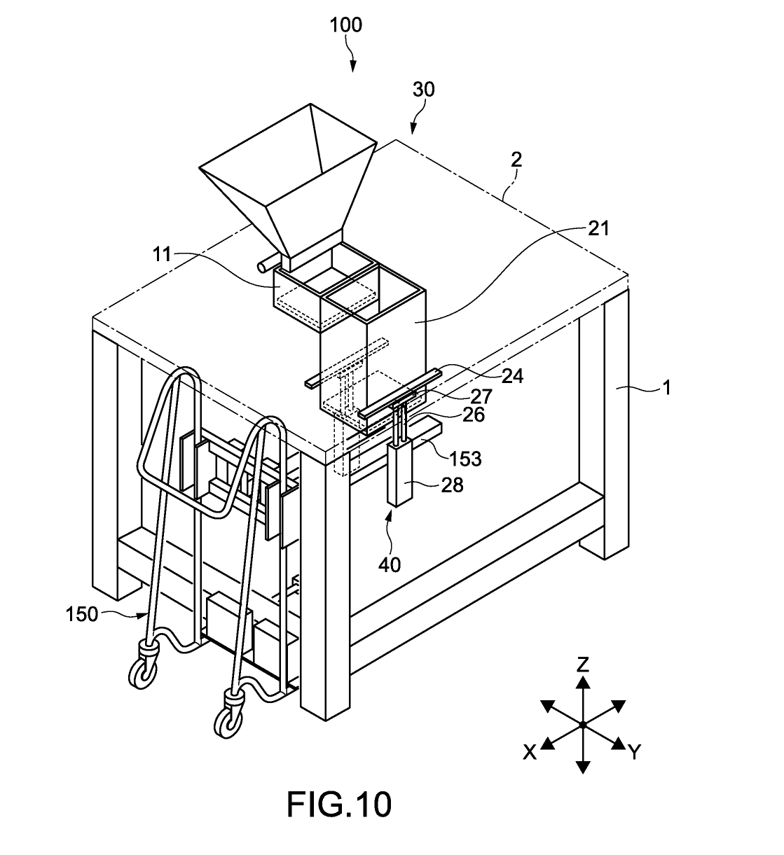

As shown in FIG. 9 and FIG. 10, the worker pushes the cart 150 so as to insert the forks 153 of the cart 150 into the modeling apparatus 100 (Step 102). Upon the insertion, the height of the box 21 is aligned with a predetermined height at which the box holding mechanism 40 is arranged, as shown in FIG. 11B. In a state shown in FIG. 11B, when the worker starts operation by means of the input operation device 62 of the modeling apparatus 100, the box holding mechanism 40 starts operation of holding the box 21.

When the worker inserts the forks 153 into the modeling apparatus 100, positioning of the box 21 in the X-direction may be performed as follows. For example, with the length of the pair of forks 153 and the size of the cart 150 being prescribed to correspond to the size of the modeling apparatus 100, positioning of the box 21 may be accomplished by merely setting the box 21 at a prescribed position on the pair of forks 153. In this case, positioning of the box 21 in the Y-direction may be accomplished by providing, for example, guiderails for moving the cart 150 that are at a position aligned with the position of the modeling apparatus 100.

Moreover, for example, a camera may be provided at the edge of the fork 153 so that the worker can observe an image captured by the camera while positioning the box 21 by pushing the cart 150 in the X- and Y-directions. Or, the worker may be able to depend on his/her skills of maneuvering the cart 150 to position the box 21 properly.

After the state shown in FIG. 11B, in the box holding mechanism 40, the supporting members 27 ascend by driving of the elevating cylinders 28 as shown in FIG. 11C. With the supporting members 27 elevating while abutting on the supported members 24, the box 21 is lifted and leaves the forks 153 (Step 103). The elevating cylinders 28 raise the supporting members 27 until the supported members 24 abut on the stoppers 83. When the supported members 24 abut on the stoppers 83, this elevating operation by the elevating cylinders 28 is completed.

FIG. 10 shows a state where the box 21 has left the forks 153 and the operation of raising this box 21 has been completed. At this stage, the upper part of the box 21 is inserted into the periphery of the guide frame 81 (see FIG. 6), whereby the box 21 is raised while being guided by the guide frame 81 and the positioning of the box 21 is completed. In this way, the box holding mechanism 40 holds the box 21.

With the elevation mechanism 50 being arranged below the box 21, the box holding mechanism 40 that holds the box 21 is formed in the simplest possible configuration to be operated by a simple movement.

The worker withdraws the forks 153 from the modeling apparatus 100 by pulling the cart 150 backward (Step 104). Taking safety into account, the worker may withdraw the forks 153 after lowering the same slightly.

Next, the elevation mechanism 50 is activated as shown in FIG. 11D. Then, the elevating arm 52 ascends such that the stage 22 is clamped by means of the clamping mechanism 56 (Step 105). When the stage 22 is clamped, as shown in FIG. 11E, the elevation mechanism 50 raises the stage 22 to the top elevation position for the main body 23 of the box 21, in other words, to the vicinity of the opening (Step 106). Then, modeling processing (see FIG. 12), which will be explained later, is started (Step 107).

As thus explained, in the present embodiment, the box 21 is held detachably by the box holding mechanism 40. This allows the worker to detach the box 21 from the box holding mechanism 40. Hence, the worker is able to take a model out of the box 21 thus detached or is able to set the box 21 accommodating the model to a powder removing apparatus 300, which will be described later. The configuration like this enhances operation efficiency.

The clamping mechanism 56 according to the present embodiment utilizes electromagnetic clamping force. According to the present embodiment, the box 21 is set detachably in the box holding mechanism 40 and the stage 22 is movably provided to the main body 23 of the box 21. Therefore, a problem of misalignment resulting from manufacturing error (for example, a difference in size) may arise between the box 21 and the stage 22. However, in the present disclosure, the electromagnetic clamping force is utilized. Therefore, it is possible to mitigate the problem of misalignment due to manufacturing error more properly than in a case where a mechanical clamping force of engaging individual members is utilized, and to perform clamping.

The box 21 according to the present embodiment has the seal member 29 provided around the peripheral edge of the stage 22 described above. This prevents powder from leaking and dropping from inside the box 21. In particular, when the seal member 29 is made of a soft material in the form of sponge as in the case of the present embodiment, a relative position between the main body 23 of the box 21 and the stage 22 in the X-Y plane is not fixed strictly, and some margin is allowed. Thus, the clamping mechanism 56 is capable of mitigating not only the above-mentioned problem of misalignment resulting from manufacturing error but also the problem of a positional difference arising from some margin allowance for the stage 22.

(Modeling Processing in Modeling Apparatus)

FIGS. 12A to 12D show modeling processing performed sequentially in the modeling apparatus 100 when viewed schematically from a side thereof.

Prior to forming a model in the modeling apparatus 100, CT data on a modeling object is input to the control unit 60.

FIGS. 12A to 12D, as described later, illustrate a process of forming one layer (having a predetermined thickness) of the powder 4 to be cured (bonded) by ink ejected from the print head 41. The power 4 and powder 4 before subjected to curing (i.e., unbonded powder) are indicated by a dotted hatching and a cured layer is shaded in black.

In FIG. 12A, the powder 4 supplied from the tank chute 15 is already accommodated in the supply box 11. On the stage 22 of the modeling section 20, layers of cured powder and uncured powder are laminated. From this state, a process of forming one cured layer is started. In FIG. 12A, the roller 16 and the print head 41 are at their standby positions.

First, as shown in FIG. 12B, the powder 4 accumulated on the supply stage 12 of the supply section 10 is pushed up by the elevation mechanism 70 (see FIG. 2, etc.), and then a slight excess of the powder 4 in an amount greater than that of one powder layer is supplied to a position higher than the position of an upper surface 2b of the plate 2. In the modeling section 20, since the stage 22 is lowered by means of the elevation mechanism 50, a gap in thickness corresponding to the thickness of one powder layer is formed between the upper surface 2b of the plate 2 and the upper surface of the powder layer of cured and uncured powder.

In FIG. 12B, the thickness u corresponding to the thickness of one powder layer is typically within a range of about 0.1 mm to 0.2 mm, but it may be greater or smaller than a thickness in this range.

As shown in FIG. 12C, the powder 4 supplied from the supply section 10 is transported as the roller 16 rotates anticlockwise and moves in a direction indicated by a hollow arrow. Here, with the roller 16 being rotated freely (free rotating force being exerted on the shaft of the roller 16) and being moved in a direction indicated by the hollow arrow, the roller 16 is rotated in a direction opposite to a direction in which this roller 16 may rotate when there is friction between the roller 16 and the modeling section 20. Because the powder 4 is transported due to this rotation of the roller 16, the gap in the upper surface of the powder layer of cured and uncured powder in the modeling section 20 is filled with the powder 4, whereby an even powder layer can be formed.

As shown in FIG. 12D, the roller 16 passes the modeling section 20 and an excess amount of the powder 4 is discharged from the discharge passage member 31. Corresponding to the roller 16 returning to its standby position, the print head 41 ejects ink to draw a color image while moving by the driving of the print head moving mechanism 46. In this case, water based ink (color and transparent ink) permeates through the powder layer, then portions of the powder 4, onto which the ink is ejected, are bonded to each other. In this way, a cured layer (a bonded layer) is formed.

In order to cure (bond) powder, the print head 41 ejects transparent ink containing a binder as described above. More specifically, a colored cured layer of powder is formed by ejecting transparent ink onto a region that has received color ink (CMY ink) ejection.

When an uncolored cured layer is formed, the print head 41 ejects only transparent ink selectively to a modeling enabled area.

The ink ejection may be started when the print head 41 starts to move after the roller 16 has transported the powder 4 and returned to its standby position. This being said, by causing the roller 16 to return to its standby position and the print head 41 to start moving at the same timing, the modeling processing may be accomplished in a shorter period of time.

When the print head 41 returns to its standby position, the operation returns to an operation mode shown in FIG. 12A and a colored cured article of one layer is formed. The modeling apparatus 100 repeats the operation as thus explained to produce laminated cured layers, which are to be formed into models.

Moreover, after performing the modeling processing in the modeling apparatus 100 as thus explained, a model exhibiting a higher degree of hardness may be obtained by heating the article by a heating apparatus (not shown in figures), which is not the modeling apparatus 100.

(Operation after Performing Modeling Processing in Modeling Apparatus)

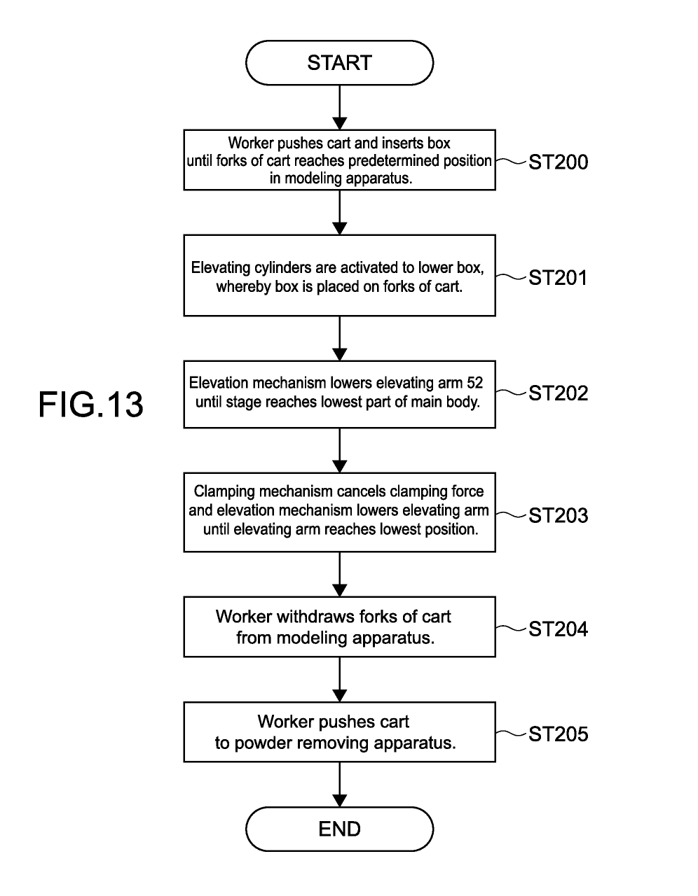

Next, operation of detaching the box 21 from the modeling apparatus 100 after the modeling processing in the modeling apparatus 100 is mainly explained. FIG. 13 shows a flowchart describing this operation.

After the modeling processing, the worker pushes the cart 150 and inserts its forks 153 into the modeling apparatus 100 so that the forks 153 are set at a predetermined position in this apparatus (Step 200). The worker may set the forks 153 to a lower position before inserting the same into the modeling apparatus 100. When the insertion of the forks 153 is implemented, the elevating cylinders 28 are activated to lower the main body 23 of the box 21, whereby the box 21 is placed on the forks 153 of the cart 150 (Step 201). During this, the main body 23 descends toward the stage 22. Then, the elevation mechanism 50 lowers the elevating arm 52 until the stage 22 reaches the lowest part of the main body 23 (Step 202).

The clamping mechanism 56 cancels clamping force to lower the elevating arm 52 until the arm 52 is in the lowest position (Step 203).

The worker withdraws the forks 153 of the cart 150 from the modeling apparatus 100 (Step 204) and pushes the cart 150 carrying the box 21 thereon, without making any modification, to the powder removing apparatus 300 (Step 205), which will be described later.

[Powder Removing Apparatus]

Next, a powder removing apparatus is explained.

(Constitution of Powder Removing Apparatus)

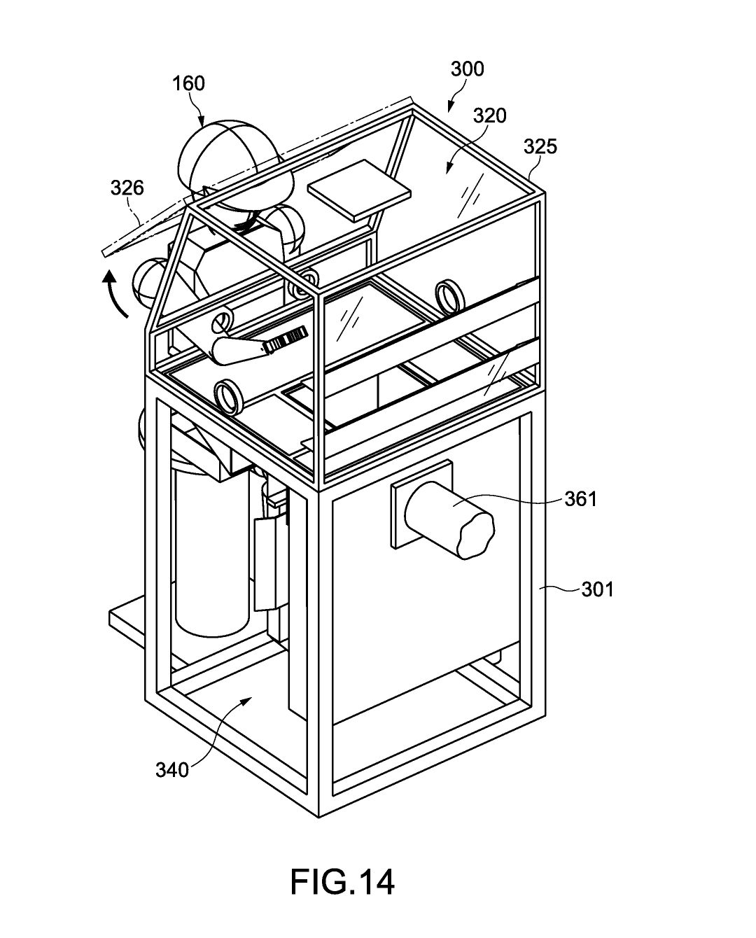

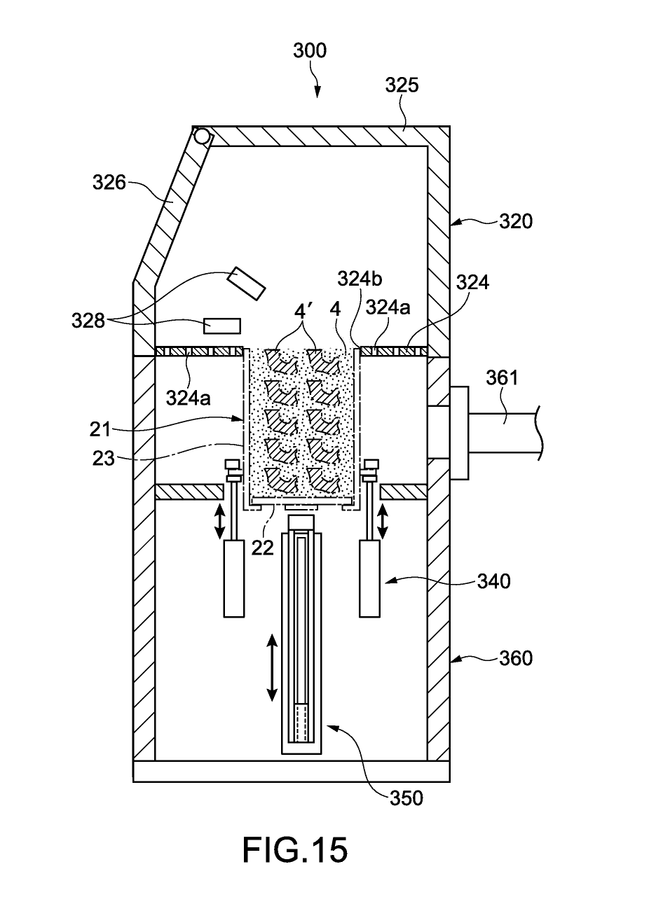

FIG. 14 shows a perspective view of an external appearance of the powder removing apparatus. FIG. 15 shows a schematic cross sectional view of the same.

The powder removing apparatus 300 has a support frame 301, a powder removing chamber 320 provided above the support frame 301, and a machinery chamber 360 provided below the powder removing chamber 320 and arranged inside the support frame 301. For example, as shown in FIG. 14, a robot 160 that removes a model from the powder removing apparatus 300 after powder removing processing is arranged in front of the powder removing apparatus 300. The robot 160 may not be configured as a humanoid robot shown in FIG. 14 and its configuration may be replaced with other configurations.

The powder removing chamber 320 has a transparent cover 325 made of, for example, acryl. The front side of this cover 325 is formed as a door 326 that can be opened and closed in the vertical direction. To this cover 325, antistatic treatment is applied to prevent electrostatically charged power from being attached thereto, so that the visibility of the inside is ensured for the user.

In the powder removing chamber 320, a nozzle 328 is provided to release gas, as shown in FIG. 15. The nozzle 328 may be provided in plurality as shown in this figure. Typically, air may be released through this nozzle, but an inert gas such as nitrogen may be also released. The nozzle 328 is connected via a pump and valve (not shown in figures) to a tank storing gas. At least, the nozzle 328 functions as the powder removing mechanism.

The box 21, a box holding mechanism 340 in which the box is held detachably, and a stage moving mechanism 350 that moves the stage 22 vertically are arranged in the machinery chamber 360. This box 21 is the box 21 set in the modeling apparatus 100. In this way, the box 21 transported by the cart 150 from the modeling apparatus 100 is set to the powder removing apparatus 300.

To the back of the machinery chamber 360, a discharge duct 361 is connected that discharges mainly unbonded powder 4 scattering inside the powder removing chamber 320. To the discharge duct 361, for example, a vacuum pump and a collecting container that collects and accommodates the powder 4, which are not shown in figures, are connected. The discharge duct 361 may be connected to the powder removing chamber 320 as well or connected to the powder removing chamber 320 only. Not only the nozzle 328 but also the discharge duct 361 function as part of the powder removing mechanism.

The structure and function of the box holding mechanism 340 are substantially identical to those of the box holding mechanism 40 in the modeling apparatus 100. Therefore, explanation of the box holding mechanism 340 is omitted.

The structure and function of the stage moving mechanism 350 are substantially identical to those of the elevation mechanism 50 of the modeling section 20 in the modeling apparatus 100. However, as long as the stage moving mechanism 350 has a constitution that supports the stage 22 and causes this stage to ascend and descend, the stage moving mechanism 350 does not have to have a constitution identical to that of the elevation mechanism 50 and may have any other types of constitution.

A partitioning member 324 that has a plurality of holes 324a in the form of, for example, a punching metal sheet, partitions the powder removing apparatus 300 into two chambers—the powder removing chamber 320 and machinery chamber 360. In the partitioning member 324, an opening 324b having a shape corresponding to the outer shape or internal diameter of the box 21 is provided. In a state where the box 21 is supported by the box holding mechanism 340, the upper part of the main body 23 of the box 21 is inserted into the opening 324b or comes into contact with the periphery of the opening 324b.

The periphery of the opening 324b of the partitioning member 324 may be provided with a guide frame as shown in FIG. 5. This guide frame may function partly as the box holding mechanism 340.

A member forming walls that cover the machinery chamber 360 is attached to the support frame 301 so that the space inside the support frame 301 is completely sealed. In this member, a window is provided into which the forks 153 of the cart 150 carrying thereon the box 21 are inserted.

(Operation of Powder Removing Apparatus)

The worker sets the cart 150, which carries thereon the box 21 accommodating a model, to the box holding mechanism 340 of the powder removing apparatus 300. Setting of the cart in this way is identical to the way of setting the same to the modeling apparatus 100. Hence, explanation of how the box 21 is set to the box holding mechanism 340 is omitted.

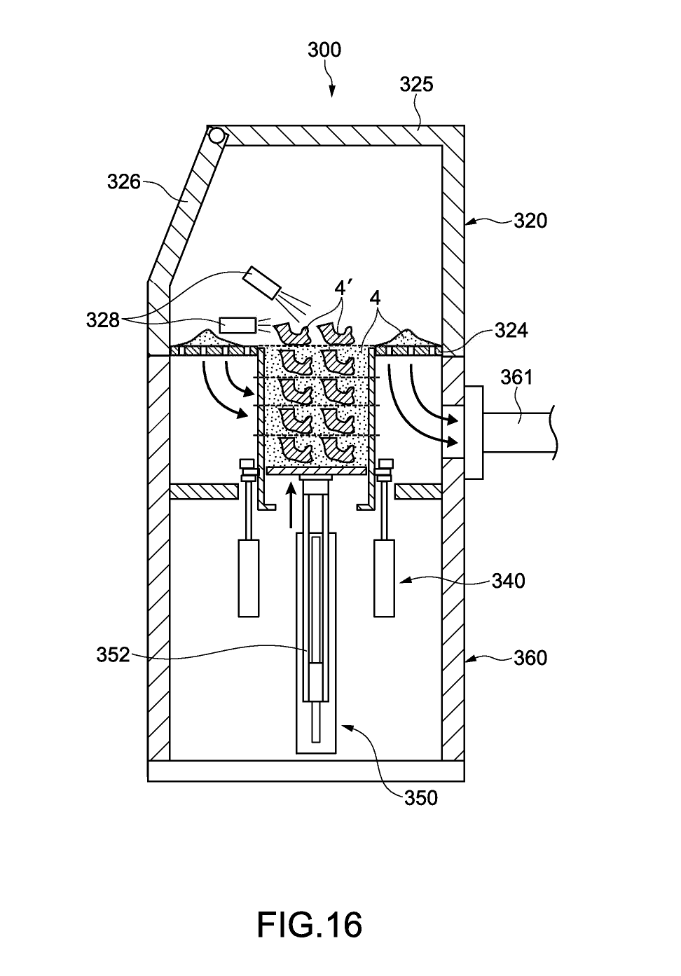

As shown in FIG. 16, an elevating arm 352 of the stage moving mechanism 350 ascends by a predetermined distance. This distance substantially corresponds to the height of one model 4′ when, for example, a plurality of the models 4 are arranged in multiple steps vertically inside the box 21. In FIG. 16, the powder 4 is divided into multiple steps by dotted lines, which indicate the height of each of these steps. With the stage 22 elevated by means of the elevating arm 352, the model 4′ on the top step is pushed out of the box 21 via the opening 23a (see FIGS. 4A and 4B) of the box 23.

Then, gas is ejected from the nozzle 328, whereby mainly unbonded (uncured) powder 4 around the model 4′ is scattered away from the model 4′. More specifically, the unbonded powder 4 is removed from the model 4′. During this powder removing processing, powder discharge by means of a vacuum pump is continuously implemented. In this way, the powder 4 is collected and accommodated in a collection container via the discharge duct 361.

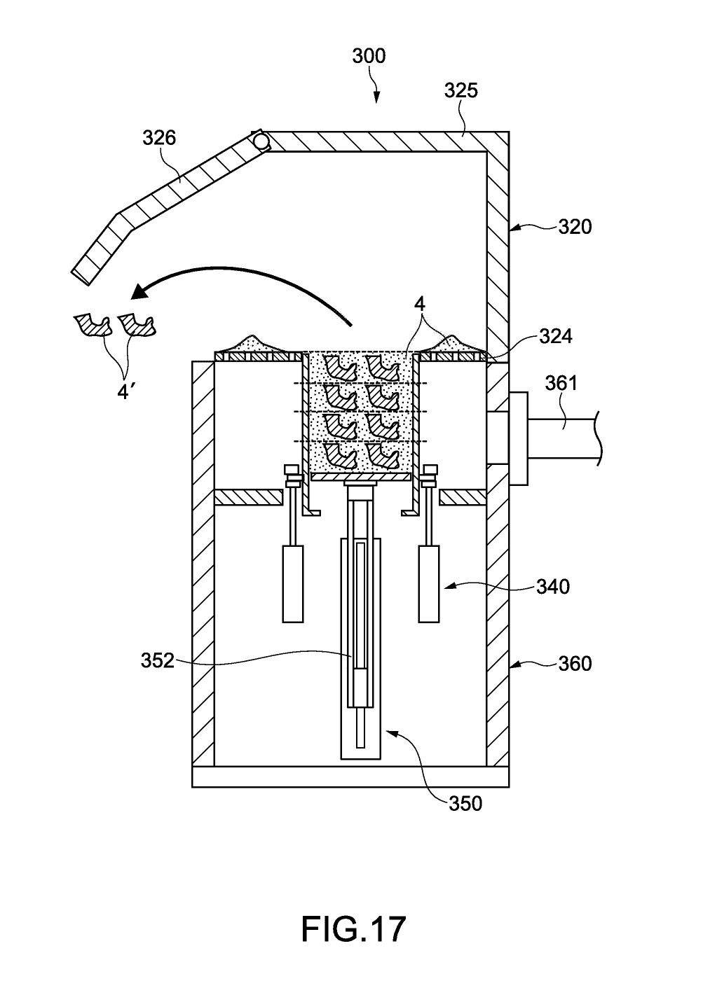

When the powder removing processing for the model 4′ at the top step in the box 21 is completed, as shown in FIG. 17, the door 326 of the powder removing chamber 320 is opened. Then, the robot 160 takes the model 4′ out of the powder removing chamber 320 and sets the same in a container (not shown in figures). When the robot 160 takes the model 4′ out of the chamber, powder discharge via the discharge duct 361 may be suspended or continued.

When the robot 160 completes the operation of taking the model 4′ at the top step out of the chamber, the door 326 of the powder removing chamber 320 is closed. Then, the elevating arm 352 of the stage moving mechanism 350 ascends by a predetermined distance. As with the case of the model 4′ at the top step, powder around another model 4′ at the second step in the box 21 is removed.

The powder removing apparatus 300 repeats this operation for a plurality of steps that have thereon models 4′ in the box 21.

When the robot 160 takes the model 4′ out of the powder removing chamber 320, the box 21 is detached from the powder removing apparatus 300. The method of detaching the box 21 from the powder removing apparatus 300 is identical to that used for detaching the box 21 from the modeling apparatus 100. Hence, explanation of how the box 21 is detached from the powder removing apparatus 300 is omitted.

The worker either detaches the empty box 21 from the cart 150 carrying thereon the empty box 21 or pushes the cart 150 carrying thereon the empty box 21 to a predetermined location.

As thus explained, according to the present embodiment, unbonded powder can be removed by the powder removing apparatus 300 for each box 21 accommodating models formed by the modeling apparatus 100. This prevents the interior of the modeling apparatus 100 from being coated with the powder 4. Moreover, when a powder-based rapid prototyping device in related art is used, which does not include a detachable box like the detachable box 21 in the present disclosure, a problem arises. For example, because the powder is scattered around the modeling section (e.g., a print head and a mechanism moving the same), when the user picks up a model buried in powder in the box, the modeling section is coated with unbonded powder. The present disclosure solves this problem.

In the present embodiment, as the stage moving mechanism 350 raises the stage 22 provided in the box 21, the model 4′ is pushed out of the box 21 through the opening 23a of the main body 23. This configuration makes it possible to provide a novel powder removing apparatus, as represented by the powder removing apparatus 300, which is able to remove the unbonded powder 4 at the upper part of the box 21.

In a modeling apparatus in related art, which is presented as a comparison to the apparatus in the present disclosure, unbonded powder drops under its own weight and is discharged from the lower part of a box. In such an apparatus, the worker has to manually take a model out of the box to implement powder removing operation. This caused a lot of inconvenience.

In a modeling apparatus (a modeling apparatus in related art, which is presented as a comparison to the apparatus in the present disclosure), in which a plurality of models are formed in a box and in which powder is discharged out of the box at one time, the plurality of models are not arranged systematically and are arranged disorderly. With such an apparatus, when the plurality of models are similar in shape but somewhat different from each other, the user faces a difficulty of distinguishing them from one another.

In a case where powder is discharged out of the box at one time, the models may topple down or collided with each other and suffer damage (of fractures, cracks or collapse).

According to the present disclosure, a group of the models 4′ placed on each of a plurality of steps is pushed out of the box one at a time before implementing powder removal. This configuration, unlike a case where unbonded powder is removed out of the box at one time, enables the plurality of models 4′ to be distinguished from one another, and groups of the plurality of models 4′ on respective steps can be taken out one after another, starting with a group on the top step. Therefore, with this configuration, the problem that arises by the use of the modeling apparatus in related art can be solved.

According to the present embodiment, in a case where a plurality of boxes 21 are prepared, while the powder removing apparatus 300 performs powder removing processing for models in a first box from among the plurality of boxes, the modeling apparatus 100 is able to perform processing of models in a second box. Unlike, for example, an apparatus in which a modeling processing section and a powder removing section are integrally formed, a modeling system configured as described in the present disclosure disallows modeling processing to be interrupted for a long time, whereby improved productivity is accomplished in forming models. As a result, cost of modeling processing can be reduced.

With the modeling apparatus 100 and the powder removing apparatus 300 being configured as separate apparatuses as shown in the present embodiment, maintenance of these apparatuses can be undertaken independently.

(Control Method for Powder Removing Processing)

As thus explained, the powder removing apparatus 300 performs powder removing operation by elevating the stage 22 by one step after another in accordance with sizes of models. In order to make use of this technology, the modeling system may be configured as explained below.

For example, the control unit 60 of the modeling apparatus 100 and a control unit (not shown in figures) of the powder removing apparatus 300 may be coupled to each other either wirelessly or through a wired connection. The powder removing apparatus 300 obtains from the control unit 60 CT data on modeling objects or data on three-dimensional shapes of modeled articles based on the CT data. Since the three-dimensional shapes data includes data on sizes and shapes of modeled articles, the control unit of the powder removing apparatus 300 is able to control powder removing processing on the basis of these data.

The control of powder removing processing signifies control of at least one of, for example, a flow rate of gas ejected from the nozzle 328, an ejection period, a speed of elevating the stage 22 (or a method of elevating this stage), the number of selected nozzles 328, and arrangement and orientation of nozzles 328.

For example, the arrangement and orientation of the nozzles 328 may be controlled by providing a driving mechanism, such as a ball screw mechanism, a rack-and-pinion mechanism, and a gear mechanism that can modify the arrangement and orientation of the nozzles 328.

Moreover, in a case where powder removing processing is performed on a model to have a portion of complex shape (a portion having a first surface area), the powder removing apparatus 300 may be able to control this processing so that the portion is subjected to the processing for a longer period of time or processed at a greater powder flow rate, compared with a portion of simpler shape (a portion having a second surface area, which is smaller than the first surface area).

In the powder removing apparatus 300, instead of acquiring data on three-dimensional shapes of models from the modeling apparatus 100, or in addition to the data acquisition, identifiers that are capable of identifying boxes individually may be provided to the plurality of boxes 21 respectively. The identifiers may be, for example, integrated circuit (IC) tags or information codes (barcodes or two-dimensional codes). By means of such identifiers, the powder removing apparatus 300 is enabled to control powder removing processing for each of the boxes 21 or each of models accommodated in the boxes 21.

The above explanation of the powder removing apparatus 300 included an example of accommodating a plurality of models in the box 21. In a case where only a single model is accommodated in the box 21, the unbonded powder 4 around the model 4′ may be removed by continuous or intermittent gas release from the nozzle 328 while the elevating arm 352 raises the stage 22 stepwise (intermittently). Or, the unbonded powder 4 may be removed while the elevating arm 352 raises the stage 22 continuously. As thus explained, even in a case where the stage 22 is raised continuously, the powder apparatus 300 may be able to variably control a speed of raising the stage 22 in accordance with the data on three-dimensional shapes of models.

### Other Embodiments

The present disclosure is not limited to the embodiment described above and other various embodiments may be implemented.

In the above-mentioned embodiment, an electromagnetic clamp is used as the clamping mechanism 56. However, a mechanism that generates clamping force by capacitance or a mechanism that generates clamping force by engagement of mechanical components may be used.

In the above-mentioned embodiment, a fluid pressure cylinder is used as a mechanism constituting a main component of the box holding mechanisms 40 and 340. However, in place of such a mechanism, a mechanism formed of, for example, a ball screw, a rack-and-pinion or a belt may be used.

In the above-mentioned embodiment, L-shaped elevating arms are used as elevating components of the elevation mechanisms 50 and 70 and the like. However, components for this mechanism are not limited to these components. The elevating components may be configured in the form of, for example, a rod.

The shape of the box is not limited to a rectangular tubular shape in the above-mentioned embodiment. The box may be a triangular tube, a pentagonal tube or a tube with more cornered shapes, or a cylinder or an elliptical cylinder, or a combination of at least two of these shapes. Alternatively, the box may have any other shape.

Unlike the arrangement of the stoppers 83 in the box holding mechanisms 40 and 340 in the above-mentioned embodiment, the arrangement of the stoppers 83 may be at a position that regulates the ascent of the box 21 at its upper side. Or, instead of the stoppers 83, the position of the box 21 that corresponds to the position of the top dead center of the elevating cylinder 28 may be used as a box holding position (a box setting position) at which the box 21 is held by the box holding mechanism 40 or 340.

In the above-mentioned embodiment, the modeling apparatus 100 and the powder removing apparatus 300 are provided as separate units, but these apparatuses may be integrated and provided as a single unit.

The present disclosure may also be applied to a modeling system in which the modeling apparatus 100 and the powder removing apparatus 300 are provided as inline units—whether these may be provided as separate units or a single unit—and in which an automatic transportation apparatus transports the box 21 between the modeling apparatus 100 and the powder removing apparatus 300. Such an automatic transportation apparatus may be a rail guided vehicle (RGV) or an automatic guided vehicle (AGV) such as a personal guided vehicle (PGV).

The automatic transportation apparatus may be a transportation apparatus having no wheel as represented by, for example, an arm-and-hand robot. When such an apparatus having no wheel is used, the modeling apparatus 100 and the powder removing apparatus 300 may be integrated with the apparatus with no wheel as a single unit.

By utilizing the data on three-dimensional shapes of models, boxes of different capacity conforming to at least sizes of models may be used. For example, when small models are produced, the control unit 60 of the modeling apparatus 100 may select small boxes in accordance with the small models. By performing modeling processing by the use of the small boxes thus selected, a total amount of powder used in the modeling processing may be reduced in comparison with a case where only the boxes of the same size are used. When boxes of different sizes are employed, their outer shapes and outer sizes may be substantially the same, as long as these boxes are formed to have different capacity sizes.

In place of the powder of materials according to the above-mentioned embodiment, metal or resin powder may be used. When metal powder is used, the powder may be bonded together (cured) by sintering. For example, laser sintering may be utilized to selectively sinter metal powder in the modeling enabled area.

Moreover, when magnetic metal powder is used and an electromagnetic clamp in the above-mentioned embodiment is used as the clamping mechanism 56, a magnetic shield may be provided to prevent a magnetic field link from being formed between the upper surface and the lower (rear) surface of the stage 22.

In the elevation mechanism 50 in the above-mentioned embodiment, the stage 22 is driven to ascend and descend with respect to the main body 23, but the main body 23 may be driven to ascend and descend with respect to the stage 22. Similarly, in the stage moving mechanism 350 of the powder removing mechanism 300 in the above-mentioned embodiment, the stage 22 is driven to ascend and descend with respect to the main body 23, but the main body 23 may be driven to ascend and descend with respect to the stage 22. In this case, the stage moving mechanism 350 is set such that the lower part of the box 21 is positioned substantially at a height of the partitioning member 324. From this position, the main body 23 may be gradually lowered.

In the above-mentioned embodiment, the control unit 60 of the modeling apparatus 100 and (the control unit of) the powder removing apparatus 300 are coupled to be able to communicate with each other. However, for example, a computer as a server may be coupled to the modeling apparatus 100 and the powder removing apparatus 300 to be able to communicate one another so that the computer is able to control the modeling apparatus 100 and the powder removing apparatus 300.

From among the features thus explained in each embodiment, at least two or more of them may be combined.

The present disclosure may employ the following configurations.

(1) A modeling apparatus, including:

a box holding mechanism;

a box including
a main body, and
a stage movably provided to the main body, the box being capable of accommodating powder and being detachably provided to the box holding mechanism;

a supply mechanism configured to selectively supply liquid that bonds the powder together to a modeling enabled area inside the box; and

an elevation mechanism configured to cause the stage to ascend and descend in the main body relative to the main body.

(2) The modeling apparatus according to (1) above, in which

the elevation mechanism includes
an elevating member that is driven to ascend and descend, and
a clamping mechanism by which the elevating member clamps the stage.
   (3) The modeling apparatus according to (2) above, in which

the clamping mechanism performs clamping by the use of an electromagnet.

(4) The modeling apparatus according to any one of (1) to (3) above, in which

the box includes a supported member that is provided on a side surface of the main body, and

the box holding mechanism includes a supporting member that is provided to be capable of ascending and descending and to support the supported member from below.

(5) The modeling apparatus according to (4), in which

the box holding mechanism includes a stopper on which the supported member supported by the supporting member abuts.

(6) The modeling apparatus according to any one of (1) to (5) above, in which

the box includes a seal member attached around the stage.

(7) A powder removing apparatus, including:

a box holding mechanism;

a box including
a main body having an opening, and
a stage movably provided to the main body, the box being detachably provided to the box holding mechanism and being capable of accommodating a model and unbonded powder with the model formed of powder by rapid prototyping technology being disposed, together with the unbonded powder, on the stage;

a stage moving mechanism capable of causing the stage to ascend in the main body relative to the main body; and

a powder removing mechanism configured to remove the unbonded powder around the model that is pushed out of the box through the opening by driving of the stage moving mechanism.

(8) A modeling system, including:

a modeling apparatus including
a box holding mechanism,
a box including
   a main body having an opening, and
   a stage movably provided to the main body, the box being capable of accommodating powder and being detachably provided to the box holding mechanism,
a supply mechanism configured to selectively supply liquid that bonds the powder together to a modeling enabled area inside the box, and
an elevation mechanism configured to cause the stage to ascend and descend in the main body relative to the main body;

a powder removing apparatus including
a box holding mechanism configured to hold the box detachably,
a stage moving mechanism capable of causing the stage to ascend in the main body relative to the main body, and
a powder removing mechanism configured to remove unbonded powder around a model that is pushed out of the box through the opening of the box by driving of the stage moving mechanism; and

a transportation apparatus configured to transport the box between the modeling apparatus and the powder removing apparatus.

(9) A method of manufacturing a model, the method including:

accommodating powder in a box including a main body and a stage movably provided to the main body;

forming in the box a model of the powder by rapid prototyping technology in a modeling apparatus;

detaching the box from the modeling apparatus;

setting the detached box to a powder removing apparatus; and

removing unbonded powder around the model by the powder removing apparatus.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A modeling apparatus, comprising:
a box holding mechanism;
a box including
a main body, and
a stage movably provided to the main body, the box being capable of accommodating powder and being detachably provided to the box holding mechanism;
a supply mechanism configured to selectively supply liquid that bonds the powder together to a modeling enabled area inside the box; and
an elevation mechanism configured to cause the stage to ascend and descend in the main body relative to the main body.

2. The modeling apparatus according to claim 1, wherein
the elevation mechanism includes
an elevating member that is driven to ascend and descend, and
a clamping mechanism by which the elevating member clamps the stage.

3. The modeling apparatus according to claim 2, wherein
the clamping mechanism performs clamping by the use of an electromagnet.

4. The modeling apparatus according to claim 1, wherein
the box includes a supported member that is provided on a side surface of the main body, and
the box holding mechanism includes a supporting member that is provided to be capable of ascending and descending and to support the supported member from below.

5. The modeling apparatus according to claim 4, wherein
the box holding mechanism includes a stopper on which the supported member supported by the supporting member abuts.

6. The modeling apparatus according to claim 1, wherein
the box includes a seal member attached around the stage.

7. A powder removing apparatus, comprising:
a box holding mechanism;
a box including
a main body having an opening, and
a stage movably provided to the main body, the box being detachably provided to the box holding mechanism and being capable of accommodating a model and unbonded powder with the model formed of powder by rapid prototyping technology being disposed, together with the unbonded powder, on the stage;
a stage moving mechanism capable of causing the stage to ascend in the main body relative to the main body; and
a powder removing mechanism configured to remove the unbonded powder around the model that is pushed out of the box through the opening by driving of the stage moving mechanism.

8. A modeling system, comprising:
a modeling apparatus including
a box holding mechanism,
a box including
a main body having an opening, and
a stage movably provided to the main body, the box being capable of accommodating powder and being detachably provided to the box holding mechanism,
a supply mechanism configured to selectively supply liquid that bonds the powder together to a modeling enabled area inside the box, and
an elevation mechanism configured to cause the stage to ascend and descend in the main body relative to the main body;
a powder removing apparatus including
a box holding mechanism configured to hold the box detachably,
a stage moving mechanism capable of causing the stage to ascend in the main body relative to the main body, and
a powder removing mechanism configured to remove unbonded powder around a model that is pushed out of the box through the opening of the box by driving of the stage moving mechanism; and
a transportation apparatus configured to transport the box between the modeling apparatus and the powder removing apparatus.

9. A method of manufacturing a model, the method comprising:
accommodating powder in a box including a main body and a stage movably provided to the main body;
forming in the box a model of the powder by rapid prototyping technology in a modeling apparatus;
detaching the box from the modeling apparatus;
setting the detached box to a powder removing apparatus; and
removing unbonded powder around the model by the powder removing apparatus.
